(19) United States
(12) Patent Application Publication
(10) Pub. No.: US 2023/0288326 A1
(43) Pub. Date: Sep. 14, 2023

(54) INSPECTION DEVICE

(71) Applicants: MITSUBISHI HEAVY INDUSTRIES, LTD., Tokyo (JP); RIKEN, Saitama (JP)

(72) Inventors: Syusaku Yamamoto, Tokyo (JP); Keisuke Kajikawa, Tokyo (JP); Yuichiro Kamino, Tokyo (JP); Hiroaki Minamide, Saitama (JP); Koji Nawata, Saitama (JP)

(73) Assignees: MITSUBISHI HEAVY INDUSTRIES, LTD., Tokyo (JP); RIKEN, Saitama (JP)

(21) Appl. No.: 18/170,855

(22) Filed: Feb. 17, 2023

(30) Foreign Application Priority Data
Mar. 9, 2022 (JP) 2022-036002

(51) Int. Cl. G01N 21/3581; G02F 1/355; G02F 1/35

(52) U.S. Cl. CPC G01N 21/3581; G02F 1/3551; G02F 1/3503; G02F 1/3505

(57) ABSTRACT

An inspection device includes: a light source for outputting pulsed excitation light with a time width of 10 picoseconds to 10 nanoseconds; a nonlinear optical crystal for generating a terahertz wave by optical wavelength conversion of the excitation light; and a detector for detecting a reflected wave of the terahertz wave reflected by an inspection target.

### TECHNICAL FIELD

The present disclosure relates to an inspection device.

This application claims the priority of Japanese Patent Application No. 2022-036002 filed on Mar. 9, 2022, the content of which is incorporated herein by reference.

### BACKGROUND

Patent Document 1 discloses a reflective terahertz wave measuring device (inspection device) configured to emit a terahertz wave which is one kind of electromagnetic waves to a surface of a structure, and is configured to detect the terahertz wave reflected from the structure. Such terahertz wave measuring device includes a terahertz wave transmitter serving as a terahertz wave transmitting means, and a terahertz wave detector serving as a terahertz wave detecting means. In such terahertz wave measuring device, a terahertz wave generating element with a resonant tunneling diode (RTD) etc. or a photoconductive antenna (PCA) is used for the terahertz wave transmitter, and a terahertz wave detection element composed of the RTD is used for the terahertz wave transmitter.

### CITATION LIST

### Patent Literature

Patent Document 1: JP2020-26991A

### SUMMARY

However, in the conventional configuration shown in Patent Document 1, since the terahertz wave transmitter is composed of the semiconductor device such as the RTD or the PCA, the terahertz wave transmitted by the terahertz wave transmitter is weak and the SN ratio (signal noise ratio) is low, making it difficult to inspect an inspection target located in a lower layer of a low-permeable material.

The present disclosure has been made in view of the above-described problems, and an object of the present disclosure is to provide the inspection device capable of inspecting the inspection target located in the lower layer of the low-permeable material.

In order to achieve the above object, an inspection device according to the present disclosure includes: a light source for outputting pulsed excitation light with a time width of 10 picoseconds to 10 nanoseconds; a nonlinear optical crystal for generating a terahertz wave by optical wavelength conversion of the excitation light; and a detector for detecting a reflected wave of the terahertz wave reflected by an inspection target.

According to an inspection device of the present disclosure, it is possible to inspect an inspection target located in a lower layer of a low-permeable material.

### BRIEF DESCRIPTION OF DRAWINGS

FIG. 1 is a view schematically showing the configuration of an inspection device according to Embodiment 1.

FIG. 2 is a view schematically showing the configuration of an inspection device according to Embodiment 2.

FIG. 3 is a view schematically showing the configuration of an inspection device according to a modified example of Embodiment 2.

FIG. 4 is a view schematically showing the configuration of an inspection device according to Embodiment 3.

FIG. 5 is a view schematically showing the configuration of an inspection device according to a modified example of Embodiment 3.

FIG. 6 is a view schematically showing the configuration of an inspection device according to Embodiment 4.

FIG. 7 is a view schematically showing the configuration of an inspection device according to Embodiment 5.

### DETAILED DESCRIPTION

An inspection device according to embodiments will be described below with reference to the accompanying drawings. It is intended, however, that unless particularly specified, dimensions, materials, shapes, relative positions and the like of components described in the embodiment or shown in the drawings shall be interpreted as illustrative only and not intended to limit the scope of the present invention.

### Embodiment 1

[Configuration of Inspection Device According to Embodiment 1]

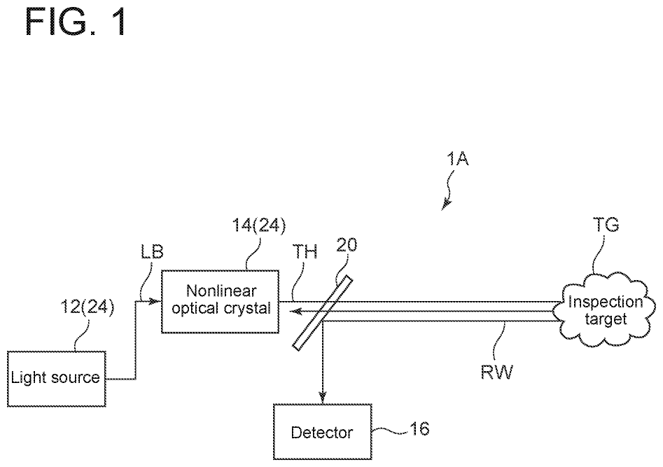

As shown in FIG. 1, an inspection device 1A according to Embodiment 1 includes a light source 12 for outputting pulsed excitation light LB with a time width of 10 picoseconds to 10 nanoseconds, a nonlinear optical crystal 14 for generating a terahertz wave TH by optical wavelength conversion of the excitation light LB, and a detector 16 for detecting a reflected wave RW of the terahertz wave TH reflected by an inspection target TG. The light source 12 is configured to output the pulsed excitation light LB, and the pulsed excitation light LB is output with a pulse time width of, for example, not greater than 1 microsecond, preferably not greater than 1 nanosecond. The light source 12 is constituted by, for example, a beam light source such as a chip laser. The nonlinear optical crystal 14 is, for example, a periodically poled lithium niobate (LiNbO₃) crystal, and the periodically poled lithium niobate crystal generates the terahertz wave TH by the backward terahertz wave TH oscillation. The terahertz wave TH is an electromagnetic wave having a frequency in the vicinity of 1012 Hz (1 trillion hertz) (0.1 to 100 THz).

The inspection target TG which is a target to be inspected by the inspection device 1A is disposed in a traveling direction of the terahertz wave TH emitted from the nonlinear optical crystal 14, and the inspection device 1A may include a half mirror 20 such that the detector 16 can detect the reflected wave RW.

[Operation of Inspection Device 1A]

In the inspection device 1A according to Embodiment 1, in the inspection of the inspection target TG, the light source 12 outputs the pulsed excitation light LB with the time width of 10 picoseconds to 10 nanoseconds. The pulsed excitation light LB is optically wavelength-converted into the terahertz wave TH by being transmitted through the nonlinear optical crystal 14, and is emitted to the inspection target TG. The terahertz wave TH emitted to the inspection target TG is reflected by the inspection target TG to be the reflected wave RW and enters the detector 16. If the inspection device 1A includes the half mirror 20, the reflected wave RW is changed in traveling direction by the half mirror 20 and enters the detector 16. The reflected wave RW having entered the detector 16 is detected by the detector 16 and used for the inspection of the inspection target TG.

[Effect of Inspection Device 1A]

With the inspection device 1A according to Embodiment 1, since the light source 12 outputs the pulsed excitation light LB with the time width of 10 picoseconds to 10 nanoseconds, the terahertz wave TH having undergone optical wavelength conversion by being transmitted through the nonlinear optical crystal 14 is stronger (higher output) than a terahertz wave emitted from the semiconductor device such as the RTD or the PCA described above. Thus, optical components 24 such as the light source 12 and the nonlinear optical crystal 14 can each be arranged at a position at a distance from the inspection target TG. For example, the optical components 24 such as the light source 12 and the nonlinear optical crystal 14 can each be arranged at a position at a distance from the inspection target TG by not less than 5 cm.

Further, even if the inspection target TG is covered with a low-permeable material, the terahertz wave TH is transmitted through the low-permeable material and reflected by the inspection target TG. Thus, even if the inspection target TG is covered with the low-permeable material, it is possible to inspect the inspection target TG.

Further, in order to ensure the signal-to-noise ratio in imaging of the low-permeable material, it is necessary to increase the output of the light source 12. However, in continuous wave oscillation such as that of a gyrotron, power consumption is large and a target may burn out. On the other hand, the light source 12 has low power consumption while ensuring high peak power, since the terahertz wave TH is pulse oscillation. Thus, non-destructive imaging can be realized with high permeability without burning out the inspection target TG.

### Embodiment 2

[Configuration of Inspection Device According to Embodiment 2]

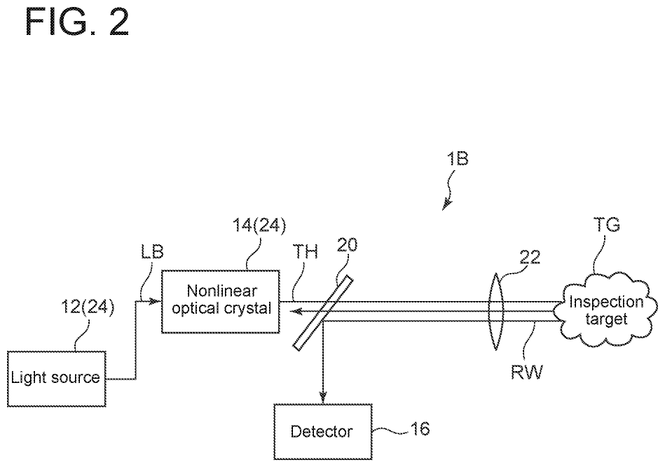

As shown in FIG. 2, an inspection device 1B according to Embodiment 2 includes, between the nonlinear optical crystal 14 and the inspection target TG, a condenser lens 22 for collecting the terahertz wave TH to irradiate the inspection target TG with the terahertz wave TH. Other configurations are the same as those of the inspection device 1A according to Embodiment 1.

[Operation of Inspection Device 1B]

In the inspection device 1B according to Embodiment 2, in the inspection of the inspection target TG, the terahertz wave TH is collected by the condenser lens 22 and emitted to the inspection target TG. Thus, the terahertz wave TH is collected to the inspection target TG, and the reflected wave RW with high resolution can be detected in the detector 16. Other operations, that is, an operation until the terahertz wave TH enters the condenser lens 22 and an operation until the reflected wave RW is detected by the detector 16 and used for the inspection of the inspection target TG are the same as those of the inspection device 1A according to Embodiment 1.

[Configuration of Modified Example of Inspection Device 1B]

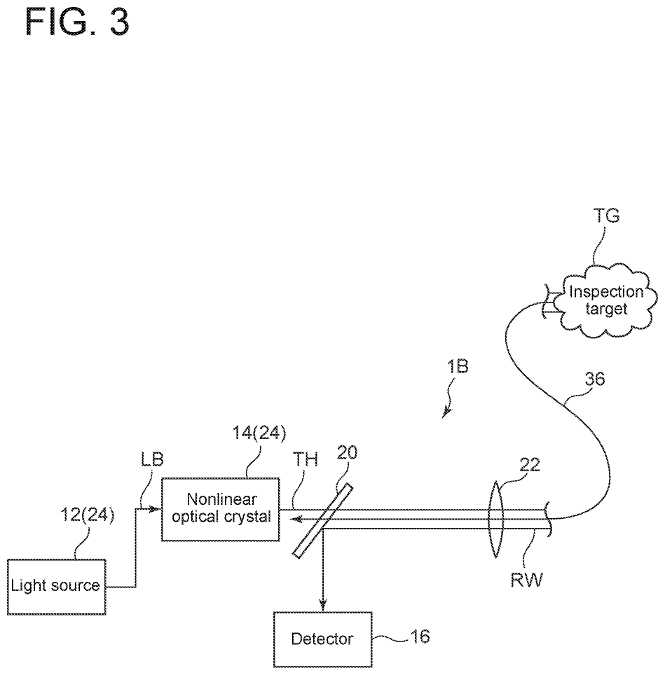

As shown in FIG. 3, in the inspection device 1B according to Embodiment 2, a terahertz wave fiber 36 may be provided between the condenser lens 22 and the inspection target TG. The terahertz wave fiber 36 is a transmission path for transmitting the terahertz wave TH and has excellent flexibility.

[Operation of Modified Example of Inspection Device 1B]

In the above-described inspection device 1B, the terahertz wave TH is emitted to the inspection target TG at any position through the terahertz wave fiber 36, and the reflected wave RW reflected by the inspection target TG is detected by the detector 16 through the terahertz wave fiber 36. Thus, it is possible to inspect the inspection target TG at any position.

### Embodiment 3

[Configuration of Inspection Device According to Embodiment 3]

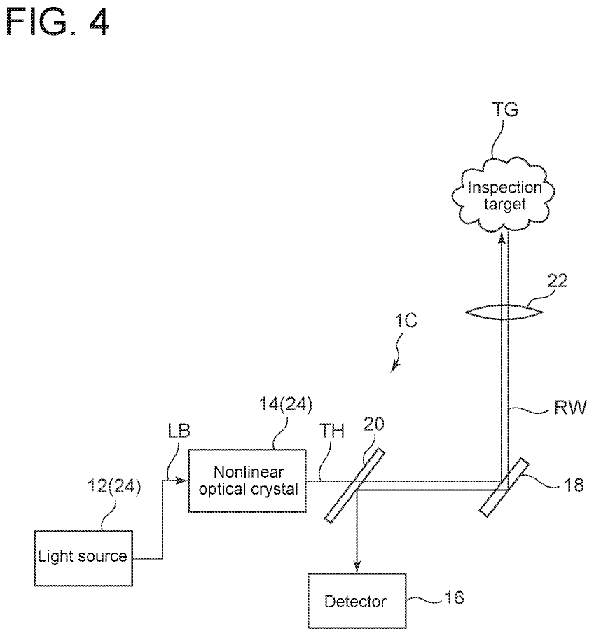

As shown in FIG. 4, an inspection device 1C according to Embodiment 3 includes a mirror 18 for reflecting the terahertz wave TH from the nonlinear optical crystal 14 at an angle of not greater than 90° with respect to the traveling direction of the terahertz wave TH. For example, in the example shown in FIG. 4, the mirror 18 deflects the terahertz wave TH from the nonlinear optical crystal 14 at an angle of 90° with respect to the traveling direction of the terahertz wave TH. Other configurations are the same as those of the inspection device 1B according to Embodiment 2.

[Operation of Inspection Device 1C]

In the inspection device 1C according to Embodiment 3, in the inspection of the inspection target TG, the terahertz wave TH is reflected by the mirror 18. Thus, it is possible to inspect the inspection target TG arranged at any position having the angle of not greater than 90° with respect to the traveling direction of the terahertz wave TH. Other operations, that is, an operation until the terahertz wave TH enters the mirror 18 and an operation until the reflected wave RW is detected by the detector 16 and used for the inspection of the inspection target TG are the same as those of the inspection device 1B according to Embodiment 2.

[Configuration of Modified Example of Inspection Device 1C]

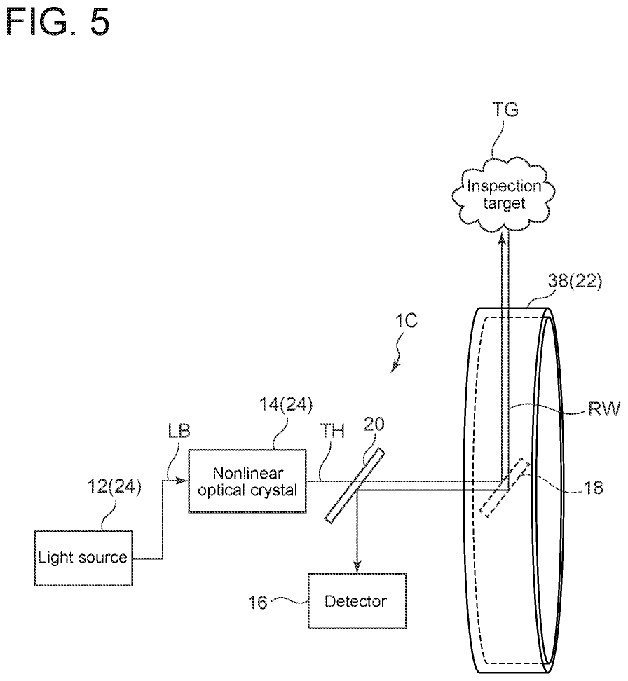

As shown in FIG. 5, in the inspection device 1C according to Embodiment 5, the condenser lens 22 may be a cylindrical lens 38. The cylindrical lens 38 is installed around the mirror 18.

[Operation of Modified Example of Inspection Device 1C]

In the above-described inspection device 1C, the terahertz wave TH reflected by the mirror 18 is collected by the cylindrical lens 38 and emitted to the inspection target TG. Thus, when the inspection target TG is a cylindrical inner circumferential surface, it is possible to inspect the inspection target TG just by rotating the mirror 18.

### Embodiment 4

[Configuration of Inspection Device According to Embodiment 4]

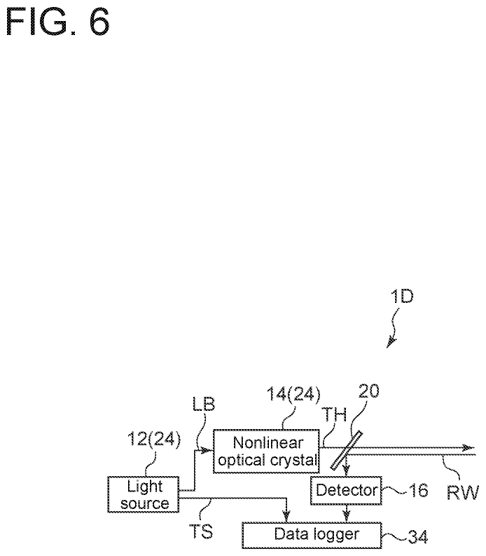

As shown in FIG. 6, an inspection device 1D according to Embodiment 4 includes a data logger 34 for storing data of the reflected wave RW detected by the detector 16. A trigger signal TS is transmitted to the data logger 34 simultaneously with the output of the excitation light LB from the light source 12, and the data logger 34 is configured to store the data of the reflected wave RW when receiving the trigger signal TS. Other configurations are the same as those of the inspection devices 1A, 1B, 1C according to Embodiments 1 to 3.

[Operation of Inspection Device 1D]

In the inspection device 1D according to Embodiment 4, in the inspection of the inspection target TG, when the data logger 34 receives the trigger signal TS transmitted simultaneously with the output of the excitation light LB from the light source 12, the detector 16 stores the data of the reflected wave RW detected by the detector 16. Thus, the data amount of the reflected wave RW stored in the data logger 34 can be reduced compared to a case where the data logger 34 continuously stores the data of the reflected wave RW. Other operations, that is, operations until the reflected wave RW is detected by the detector 16 are the same as those of the inspection devices 1A, 1B, 1C according to Embodiments 1 to 3.

### Embodiment 5

[Configuration of Inspection Device According to Embodiment 5]

The inspection target TG of an inspection device 1E according to Embodiment 5 is, for example, a steel pipe SP. The steel pipe SP has an inner peripheral surface lined with a resin material RM and if the resin material RM deteriorates, water impregnates and an inner wall of the steel pipe SP corrodes. The inspection device 1E according to Embodiment 5 aims to inspect how much the corrosion of the inner wall of the steel pipe SP has progressed.

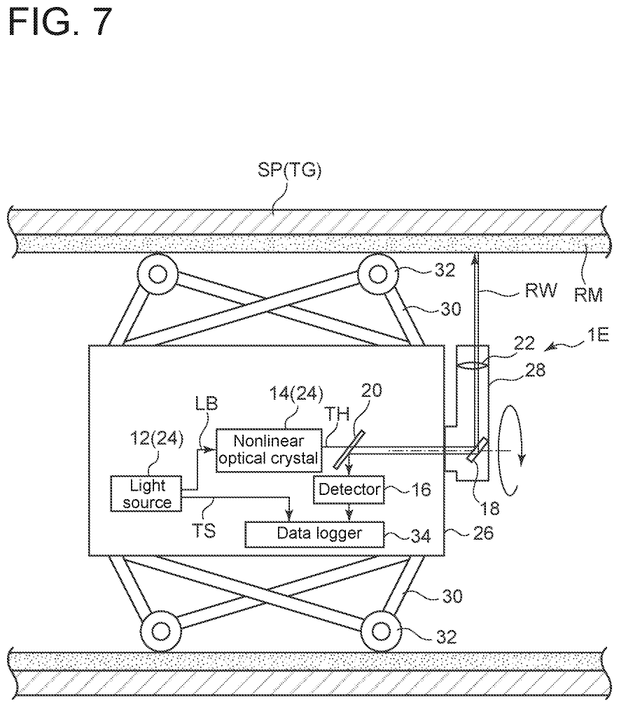

As shown in FIG. 7, the inspection device 1E according to Embodiment 5 includes a housing 26 for accommodating the light source 12, the nonlinear optical crystal 14, and the detector 16, and an arm mechanism 28 for accommodating the mirror 18 and the condenser lens 22. The arm mechanism 28 has one end where the mirror 18 is disposed and another end where the condenser lens 22 is disposed, and the arm mechanism 28 is rotatably mounted on the housing 26 at the one end. Then, the arm mechanism 28 whose one end is rotatably mounted is rotated by an actuator such as a motor (not shown).

The light source 12 and the nonlinear optical crystal 14 are disposed such that the terahertz wave TH emitted from the nonlinear optical crystal 14 passes through a rotation center of the arm mechanism 28, and are accommodated in the housing 26. The mirror 18 is disposed at the rotation center of the arm mechanism 28 and accommodated in the arm mechanism 28. The condenser lens 22 is disposed on an optical path of the terahertz wave TH reflected by the mirror 18 and accommodated in the arm mechanism 28.

For example, the housing 26 is provided with a cylindrical multi-axis arm 30 for placing on an outer circumference thereof the housing 26 at an axial center of the steel pipe SP. Respective arms of the multi-axis arm 30 are disposed at equal intervals in the circumferential direction of the housing 26 and are configured to extend radially outward of the housing 26. Each arm of the multi-axis arm 30 is in the shape of a pantograph, and includes at a joint portion a columnar support portion 32 for supporting the housing 26 in an inner circumference of the steel pipe SP.

For example, the arm mechanism 28 can optionally set a distance from the mirror 18 to the condenser lens 22. Thus, it is possible to bring the condenser lens 22 close to an inner circumferential surface of the steel pipe SP.

Other configurations are the same as those of the inspection devices 1A, 1B, 1C, 1D according to Embodiments 1 to 4.

[Operation of Inspection Device 1E]

In the inspection device 1E of Embodiment 5, in the inspection of the inspection target TG, the housing 26 is placed at the axial center of the steel pipe SP which is the inspection target TG by extending each arm of the multi-axis arm 30 radially outward of the housing 26 inside the steel pipe SP which is the inspection target TG. Then, the arm mechanism 28 is rotated with respect to the housing 26 by the actuator such as the motor (not shown). Consequently, the mirror 18 and the condenser lens 22 are also rotated, allowing an inner wall surface of the steel pipe SP to be inspected.

Other operations, that is, operations until the reflected wave RW detected by the detector 16 is stored in the data logger 34 are the same as those of the inspection devices 1A, 1B, 1C, 1D according to Embodiments 1 to 4.

[Modified Example of Inspection Device 1E]

In the inspection device 1E according to Embodiment 5, the housing 26 is provided with the multi-axis arm 30. However, if wheels are provided in the housing 26 instead of the multi-axis arm 30, the steel pipe SP extending in the horizontal direction is movable. Then, by rotating the arm mechanism 28 while moving the inspection device 1E in the horizontal direction, a tip of the arm mechanism 28 spirally turns, making it possible to efficiently inspect corrosion of the inner wall surface of the steel pipe SP.

The present invention is not limited to the above-described embodiments, and also includes an embodiment obtained by modifying the above-described embodiments and an embodiment obtained by combining these embodiments as appropriate.

For example, if the inspection devices 1A, 1B, 1C, 1D, 1E according to the Embodiments 1 to 5 described above are mounted on a vehicle, it is possible to inspect a tunnel as the inspection target TG.

Further, for example, if the inspection devices 1A, 1B, 1C, 1D, 1E according to the Embodiments 1 to 5 described above are mounted on a flying object such as a drone, it is possible to inspect a vertically extending object such as a stack as the inspection target TG.

The contents described in the above embodiments would be understood as follows, for instance.

An inspection device (1A to 1E) according to an aspect of [1] includes: a light source (12) for outputting pulsed excitation light (LB) with a time width of 10 picoseconds to 10 nanoseconds; a nonlinear optical crystal (14) for generating a terahertz wave (TH) by optical wavelength conversion of the excitation light (LB); and a detector (16) for detecting a reflected wave (RW) of the terahertz wave (TH) reflected by an inspection target (TG).

With such configuration, the terahertz wave (TH) generated by the nonlinear optical crystal (14) is stronger (higher output) than the terahertz wave emitted from the semiconductor device. Thus, the optical components (24) such as the light source (12) and the nonlinear optical crystal (14) can each be arranged at a position at a distance from the inspection target (TG). Further, since the terahertz wave (TH) generated by the nonlinear optical crystal (14) has the higher output than the terahertz wave emitted from the semiconductor device, the terahertz wave (TH) generated by the nonlinear optical crystal (14) is transmitted through a low-permeable material through which the terahertz wave (TH) emitted from the semiconductor device is hardly transmitted. On the other hand, since the light source (12) outputs the pulsed excitation light (LB), continuous irradiation with the terahertz wave (TH) is avoided, making it possible to suppress burnout of the low-permeable material. Thus, the inspection device (1A to 1E) can inspect the inspection target (TG) located in a lower layer of the low-permeable material.

An inspection device (1B to 1E) according to another aspect is the inspection device as defined in [1], including a condenser lens (22) for collecting the terahertz wave (TH) to irradiate the inspection target (TG) with the terahertz wave (TH).

With such configuration, since the terahertz wave (TH) generated by the nonlinear optical crystal (14) is collected by the condenser lens (22) and emitted to the inspection target (TG), the terahertz wave TH is collected to the inspection target TG, and the reflected wave (RW) with high resolution can be detected in the detector (16).

An inspection device (1C to 1E) according to another aspect is the inspection device as defined in [2], including a mirror (18) for deflecting the terahertz wave (TH) from the nonlinear optical crystal (14) at an angle in a range from 45° to 135° with respect to a traveling direction of the terahertz wave (TH). The terahertz wave (TH) reflected by the mirror (18) enters the condenser lens (22).

With such configuration, the mirror (18) deflects the terahertz wave (TH) from the nonlinear optical crystal (14) at the angle in the range from 45° to 135° with respect to the traveling direction of the terahertz wave (TH). Then, the terahertz wave (TH) reflected by the mirror (18) enters the condenser lens (22), is collected, and is emitted to the inspection target (TG). Thus, by adjusting the mirror (18) at the angle in the range from 45° to 135° with respect to the traveling direction of the terahertz wave (TH), it is possible to inspect the inspection target (TG) arranged at any position having the angle from 45° to 135° with respect to the traveling direction of the terahertz wave (TH).

An inspection device (1E) according to another aspect is the inspection device as defined in [3], including: a housing (26) for accommodating the light source (12), the nonlinear optical crystal (14), and the detector (16); and an arm mechanism (28) for accommodating the mirror (18) and the condenser lens (22). The arm mechanism (28) has one end where the mirror (18) is disposed and another end where the condenser lens (22) is disposed, and the arm mechanism (28) is rotatably mounted on the housing (26) at the one end.

With such configuration, by rotating the arm mechanism (28), the another end where the condenser lens (22) is disposed draws a circle around the one end where the mirror (18) is disposed. Thus, it is possible to inspect the inner wall surface of a cylinder (for example, the steel pipe (SP)) having the one end where the mirror (18) is disposed as the center and the another end where the condenser lens (22) is disposed as the outer circumference.

An inspection device (1A to 1E) according to another aspect is the inspection device as defined in any one of [1] to [4], including: a data logger (34) for storing data of the reflected wave (RW) detected by the detector (16). A trigger signal (TS) is transmitted to the data logger (34) simultaneously with the output of the excitation light (LB) from the light source (12), and the data logger (34) is configured to store data of the reflected wave (RW) when receiving the trigger signal (TS).

With such configuration, since the data logger (34) stores the data of the reflected wave (RW) when receiving the trigger signal (TS), the data amount of the reflected wave (RW) stored in the data logger (34) can be reduced compared to a case where the data logger (34) continuously stores the data of the reflected wave (RW).

An inspection device (1E) according to another aspect is the inspection device as defined in [4], wherein the housing (26) is configured to be movable.

With such configuration, the long inspection target (TG) can be inspected by moving the housing (26).

1. An inspection device, comprising:
a light source for outputting pulsed excitation light with a time width of 10 picoseconds to 10 nanoseconds;
a nonlinear optical crystal for generating a terahertz wave by optical wavelength conversion of the excitation light; and
a detector for detecting a reflected wave of the terahertz wave reflected by an inspection target.

2. The inspection device according to claim 1, comprising a condenser lens for collecting the terahertz wave to irradiate the inspection target with the terahertz wave.

3. The inspection device according to claim 2, comprising a mirror for deflecting the terahertz wave from the nonlinear optical crystal at an angle in a range from 45° to 135° with respect to a traveling direction of the terahertz wave,
wherein the terahertz wave reflected by the mirror enters the condenser lens.

4. The inspection device according to claim 3, comprising:
a housing for accommodating the light source, the nonlinear optical crystal, and the detector; and
an arm mechanism for accommodating the mirror and the condenser lens,
wherein the arm mechanism has one end where the mirror is disposed and another end where the condenser lens is disposed, and the arm mechanism is rotatably mounted on the housing at the one end.

5. The inspection device according to claim 1, comprising a data logger for storing data of the reflected wave detected by the detector,
wherein a trigger signal is transmitted to the data logger simultaneously with the output of the excitation light from the light source, and the data logger is configured to store data of the reflected wave when receiving the trigger signal.

6. The inspection device according to claim 4,
wherein the housing is configured to be movable.
